(19) United States
(12) Patent Application Publication
(10) Pub. No.: US 2012/0179803 A1
(43) Pub. Date: Jul. 12, 2012

(54) ENHANCING NETWORK-BASED IP MOBILITY MANAGEMENT PROTOCOL TO PROVIDE MULTIHOMING SUPPORT

(76) Inventors: Telemaco Melia, Nozay (FR); Yacine Mghazli, Nozay (FR)

(21) Appl. No.: 13/381,456

(22) PCT Filed: Jun. 30, 2010
(86) PCT No.: PCT/EP10/59285

§ 371 Date: Apr. 2, 2012

(30) Foreign Application Priority Data
Jul. 3, 2009 (EP) 092920538.9

(51) Int. Cl. G06F 15/173

(52) U.S. Cl. 709/223

(57) ABSTRACT

In an embodiment, there is provided a method for enhancing a network-based IP mobility management protocol to provide multihoming support, said method including providing multihoming support based on multihoming group information, said information identifying a group of interfaces of a Mobile Node MN to be managed by a Local Mobility Anchor LMA on a Mobile Access Gateway MAG demand under a same mobility session.

### CROSS-REFERENCE TO RELATED APPLICATIONS

This application is based on European Patent Application No. 09290538.9 filed Jul. 3, 2009, the disclosure of which is hereby incorporated by reference thereto in its entirety, and the priority of which is hereby claimed under 35 U.S.C. §119.

### FIELD OF THE INVENTION

The present invention generally relates to mobile communication networks and systems, and to mobility management protocols in such networks and systems.

### BACKGROUND

Detailed descriptions of mobile communication networks and systems, and mobility management protocols in such networks and systems, can be found in the literature, such as in particular literature published by standardisation bodies, such as IETF for IP mobility management.

### SUMMARY

Network-based IP mobility management protocols, such as in particular Proxy Mobile IPv6, PMIPv6 (as specified in RFC 5213) have a number of advantages as compared to host-based IP mobility management such as Mobile IPv6; however currently specified network-based IP mobility management protocols, such as in particular PMIPv6, fail to provide adequate multihoming support.

There is a need to provide such multihoming support, in particular for PMIPv6. More generally, there is a need to improve network-based IP mobility management protocols.

Embodiments of the present invention in particular address such needs.

These and other objects are achieved, in one aspect, in an embodiment, by a method for enhancing a network-based IP mobility management protocol to provide multihoming support, said method including providing multihoming support based on multihoming group information, said information identifying a group of interfaces of a Mobile Node MN to be managed by a Local Mobility Anchor LMA on a Mobile Access Gateway MAG demand under a same mobility session.

These and other objects are achieved, in another aspect, by entities, such as in particular Mobile Access Gateway MAG, and Local Mobility Anchor LMA, for performing such method.

### BRIEF DESCRIPTION OF THE DRAWINGS

Some embodiments of apparatus and/or methods in accordance with embodiments of the present invention are now described, by way of example only, and with reference to the accompanying drawings, in which:

FIG. 1 schematically illustrates multihomed Mobile Node with PMIPv6 extensions,

FIG. 2 schematically illustrates mobility session extended for multihoming,

FIG. 3 schematically illustrates initial multihoming setup,

FIG. 4 schematically illustrates multihoming renewal,

FIG. 5 schematically illustrates multihoming filters modification,

FIG. 6 schematically illustrates multihoming interface removal,

FIG. 7 schematically illustrates multihoming interface addition,

FIG. 8 schematically illustrates multihoming option,

FIG. 9 schematically illustrates FID Option Action values.

### DESCRIPTION OF EMBODIMENTS

In one aspect, embodiments of the present invention provide extensions to Proxy Mobile IPv6 in order to support multihomed mobile nodes (MN). These extensions are intended

to permit such mobile nodes to send and receive IP packets on multiple interfaces in a simultaneous and possibly discriminated

manner when attached to a PMIPv6 domain. A typical usage of these

extensions is to perform downlink flow discrimination through

multiple interfaces based on filtering rules (e.g. dedicate one MN

interface to VOIP traffic and another MN interface to HTTP

The proposed extensions to PMIPv6 attempt to increment in a backward

compatible manner the current PMIPv6 specification.

Proxy Mobile IPv6 (PMIPv6), specified in [RFC52 3], provides network

based mobility management to hosts connecting to a PMIPv6 domain.

PMIPv6 introduces two functional entities, the Local Mobility Anchor

(LMA) and the Mobility Access Gateway (MAG). The MAG is the first

layer-three hop detecting MN attachment and providing IP

connectivity. The LMA is the entity assigning one or more HNP to the

MN and is the topological anchor for all traffic from/to the MN.

PMIPv6 allows a MN to connect to the same PMIPv6 domain through

multiple interfaces (such MN being called multihomed MN). However in such a case, PMIPv6 requires each

interface to be assigned a distinct IPv6 address and thus prevents

from multihoming capabilities. IETE NETEXT Working Group “Multiple Interface Support with Proxy Mobile IPv6”, March 2009, studies how to support

multihoming in PMIPv6 and identifies three possible models regarding

IPv6 address management:

unique prefix per interface

unique address per interface

shared address across interfaces.

It further describes topics associated with each model, in

particular handover behavior and security aspects.

In the following description of an embodiment of the present invention, the shared address across interfaces model will be considered, as an example. In this example, the focus is intended to match the

case where a multihomed MN is known by its Internet peers under the

same address while the PMIPv6 domain it is attached to can perform,

on its own criteria, packets delivery through the suited MN

interface. As a consequence, only a

single Home Network Prefix (HNP) is associated to a multihomed MN

in a PMIPv6 domain. Other examples could be envisaged.

In the following description of an embodiment of the present invention, the interface “handover” or “mobility”

terminology that can be perceived as confusing in the multihoming

context (where MN interfaces are used simultaneously) will not be re-used. Instead, the

concept of multihoming group (a logical set

of interfaces of a MN) is introduced, and the support of elementary

operations (addition, modification, removal) on a group entity for a

MN is provided. Such terminology is expected to be more suited to the general

multihoming paradigm. In the following description of an embodiment of the present invention, in an example, a default multihoming group

(id=0) is defined to represent all interfaces of a given MN.

The functional usage of multihoming MN capabilities in a PMIPv6

domain is defined in a flexible and

multi-purpose manner. This allows for various traffic processing in

a PMIPv6 domain with multihomed MN such as (not limited to): traffic

blocking, traffic load-balancing or traffic dissemination. To

achieve this flexibility, the concept of “filter” is used to denote a unitary criteria that can be managed between a MAG and a

LMA in relationship with a MN interface. Unitary filters can be

added, deleted and modified on a per multihoming group basis.

Flexibility is achieved by allowing an arbitrary filter syntax (or

grammar) as proposed in IETF MEXT Working Group, “Flow bindings in Mobile IPv6 and Nemo Basic Support”, April 2009. The filter syntax is a matter of

agreement between MAG and LMA entities.

FIG. 1 depicts the general principles of PMIPv6

extensions for multihoming support as proposed in an embodiment of the present invention.

When MN activates if1, MAG1 selects the default multihoming group and

perform proxy registration toward the LMA. MAG1 provides filters

(flow 1) during registration. LMA accepts proxy registration from

MAG 1 and allocates MN addr according to the shared address model.

Since proxy registration is requesting multihoming support, LMA

stores MAG1 filters that come along with delivery to pCoA1.

When MN activates if2, MAG2 selects the default multihoming group and

perform proxy registration toward the LMA. MAG2 provides filters

(flow2) during registration. LMA accepts proxy registration from

MAG2 and allocates MN addr according to the shared address model.

LMA stores MAG2 filters that come along with delivery to pCoA2.

Later on, LMA receive IP packets destinated to MN addr. The LMA

attempts to match each IP packet against filters (flow1, flow2) stored for the MN addr. When a filter match (flow1 or flow2), the LMA perform the action for the IP packet in the context of the matching flow. In particular if the IP packet is to be delivered, the LMA performs delivery using the pCoA associated to the filter

(pCoA1 on flow1 or pCoA2 on flow2).

LMA behavior is extended to allow simultaneous transmission of

downlink (DL) packets to the mobile node ac s multiple interfaces.

No assumption is done on how the MN performs uplink (UL) packets

transmission. The MN might either use a single interface for UL or

select an interface according to existing or new mechanisms such as

the ones being defined by the IETF MIF working group.

Both LMA and MAG behaviors are extended to provide enhanced Proxy

Binding management for multihomed MN. LMA shall support Binding

Control Entries (BCE) of multihomed type. This includes the

capability to refer to a multihoming group id (mhgid) and a set of

filters in a BCE. This also includes mechanism to allocate a unique

HNP per MN when multihoming is used. LMA shall support or delegate

the downlink packet processing and delivery according to flow

specifications. Both MAG and LMA shall be able to manage flows on a

per multihomed MN basis. Downlink flows are created/deleted/modified

at LMA level on MAG request using PBU/PBA exchanges.

In an embodiment, it is proposed to extend PMIPv6 to support multiple

proxy CoAs per mobility session possibly associated with downlink

transmission criteria using the flow concept.

Upon MN attachment the MAG determines if the MN should be provided

with multihoming service and, if so, selects the flow configuration

that should be put in place for delivery through itself. he MAG can

learn this information, for example through a policy store or using attachment-specific

signalling. If the MAG determines that the MN can

use the multihoming service it forms a PBU as per [RFC5213] and adds

a Multihoming Option (as proposed in an embodiment of the present invention) and possibly

one or several Flow Identifier option(s) as defined in the above-recalled MEXT document. The

Multihoming option aims at identifying (MHGID) and parameterize the

multihoming group to be managed (created/updated/deleted) by the LMA on MAG

demand. The choice of identification of the multihoming group

may follow the following rule:

All PBUs with the same HNP and MHGID values belong to the same

mobility session from the LMA perspective.

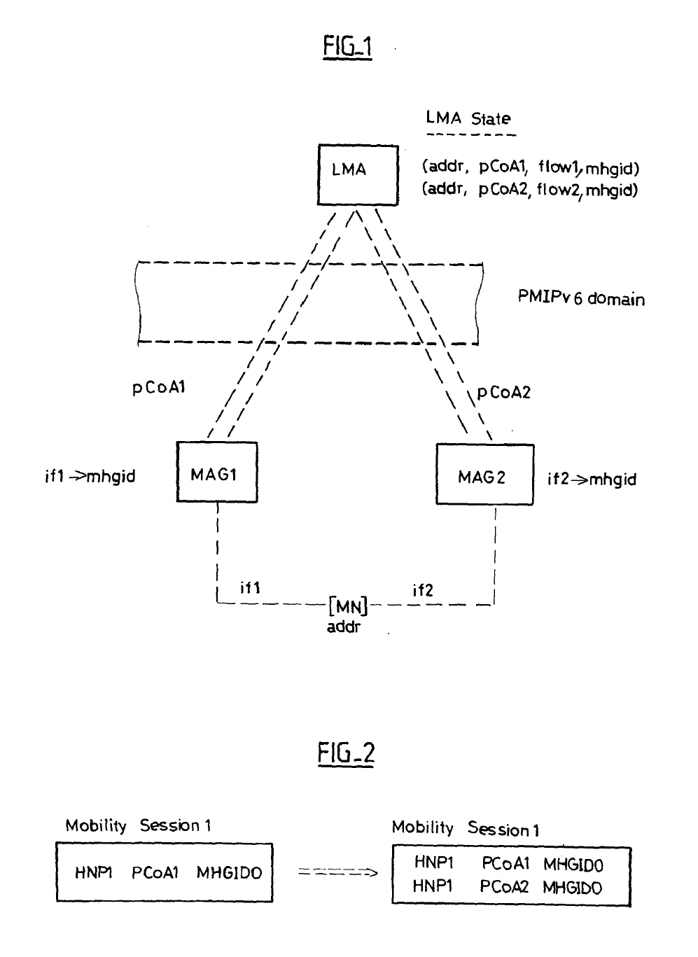

FIG. 2 shows how the mobility session is extended to span the same

HNP across multiple interfaces. This updates the text in [RFC5213]

where each single interface is managed under a different mobility

session. The MHGID, selected by MAG1 (corresponding to PCoA1) upon

MN attachment, is stored at the LMA. When the MN attaches to MAG2

(corresponding to PCoA2) MAG2 selects its MHGID value. If both MAG1

and MAG2 MGHID and HNP values match then the LMA adds PCoA2—MHGID0

to the already existing mobility session.

The MAG treats the indication of multihoming as an explicit

indication of adding flows to the PBU if any. Such flows can be

learned for instance during MN access to the network.

Upon reception of a PBU containing indication for multihoming the LMA

should perform a binding cache lookup and append the information to

the found BCE. Filters, if present, are extracted from the PBU and processed by the LMA. The result of Filters processing is returned in the PBA by the LMA on an individual basis.

Examples of flow charts for multihoming setup,

renewal, filters modifications and interface removal/addition will now be described.

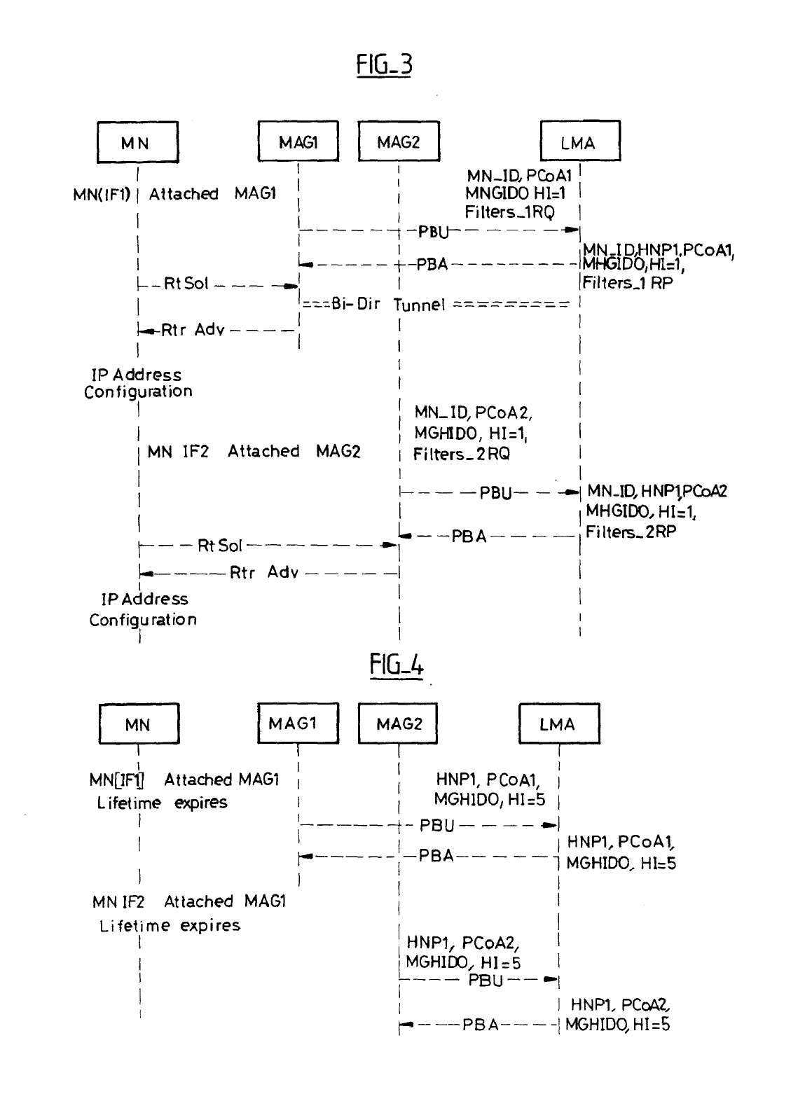

FIG. 3 shows Initial multihoming setup.

FIG. 3 shows the attachment of IF1 and subsequently the attachment

of IF2. IF1 and IF2 belongs to the same multihoming group ID (i.e.

the default multihoming group id 0).

FIG. 4 shows Multihoming renewal:

FIG. 4 shows how binding renewal upon lifetime expiration is done.

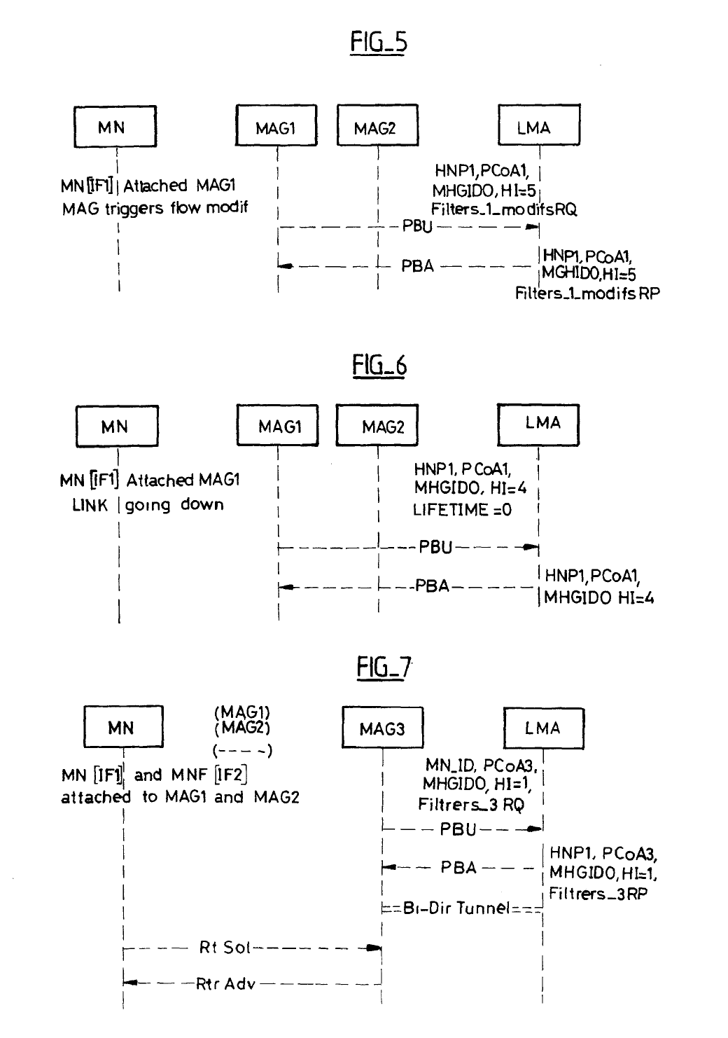

FIG. 5 shows Multihoming filters modification

Filters can also be modified upon reception of an internal or

external MAG trigger FIG. 5. From the PMIPv6 point of view,

filters modification is carried by binding renewal semantics (HI=5).

The target multihoming group is set by the MAG in the multihoming

option (MHGID field). This allows MAG to modify at any time the

downlink filters it is responsible for.

FIG. 6 shows Multihoming interface removal

FIG. 6 shows how to remove an interface from a multihoming group

managed by a MAG for a given MN. The target multihoming group is set

by the MAG in the multihoming option (MHGID field).

FIG. 7 shows Multihoming interface addition

FIG. 7 addresses the case where the MN adds a third interface to

the same multihoming group for a given MN. The target multihoming

group is set by the MAG in the multihoming option (MHGID field).

The following extensions to the protocol options as

defined in [RFC5213], as provided in an embodiment of the present invention, will now be described.

FIG. 8 shows the Multihoming option.

Following fields are provided:

Type

TBA

Length
8-bit unsigned integer indicating the length of the option in octets, excluding the type and length fields. This field MUST be set to 2.

MHGID

This 8 bit field identifies the multihoming group the PBU/PBA refer to.

The value 0 is reserved to the default multihoming group which includes

all interfaces of a MN. Only value 0 can be supported.

ACT

This 3-bit field is used to provide optional action to be performed by LMA upon removal of an interface from a multihoming group. The field shall only be set by the MAG when HI value in PBU is set to 4, otherwise the field shall be set to 0.

The following bit values are currently defined:

000: Reserved

001: Remove filters

010: Keep filters

RFU (Reserved for Future Use)
This 5-bit field is unused for now. The value MUST be initialized to 0 by the sender and MUST be ignored by the receiver.

The following considerations on the ACT field may apply. If 001 (Remove filters) is set on interface removal, the LMA shall remove all filters currently configured. This might result in downlink traffic disruption. If 010 (Keep filters) is set on interface removal, the LMA shall arrange to re-instantiate filters configured on the removed

interface to existing filters (if any) of other interfaces of the multihoming group if any. This allows to avoid downlink traffic disruption. The implementation of this action at LMA level can be

specified. However, a filter that has been

re-instantiated on a interface should be advertised by the LMA with a

specific status of Flow identifier option whenever a MAG perform a

filter operation the interface.

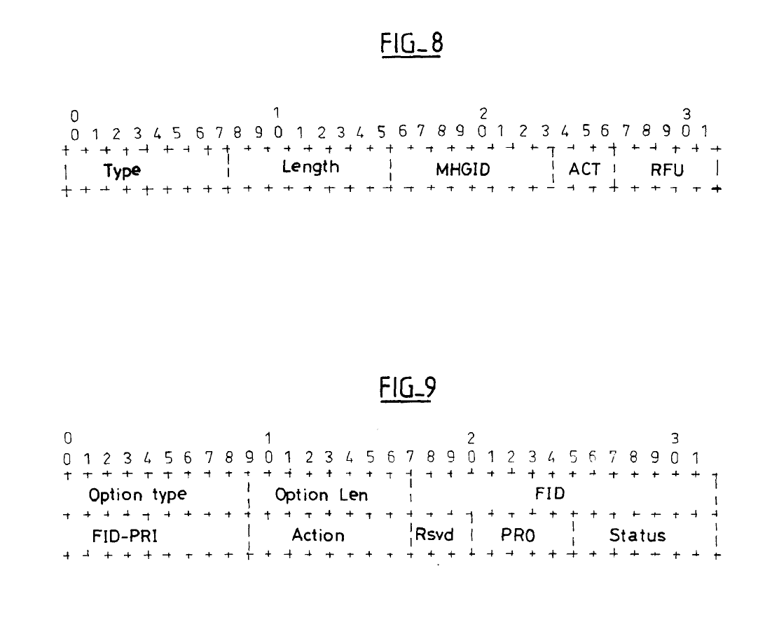

FIG. 9 shows the Flow Identifier Option

The FID option defined in the above-recalled MEXT document can be used to manage downlink packet delivery across interfaces of

a multihomed MN. The option might be used by a MAG to create/modify/delete

filter(s) on the LMA for a particular multihoming group of a

MN. Upon successful processing and installation of filter(s) at LMA

level an individual status (Status field) shall be returned to the MAG by the LMA. The LMA should later evaluate packets destinated to

a MN through filters installed by MAG(s) that are proxying the MN

under the same mobility session. The LMA can perform he action(s)

associated to the matching filter(s).
In case, the LMA re-instantiates flows on a multihoming interface group toward a MAG for a given MN, the LMA can perform the following processing:
Allocate a unique FID to the re-instantiated filter within the context of existing filters for the multihoming group of the MN toward the target LMA
Set the PRO field to a new reserved value (2: flow binding re-instantiated by LMA) of [MEXT] as proposed by the current specification
Copy FID-PRI and Action fields from the original filter into the re-instantiated filter

Since no notification mechanism is currently defined between MAG and

LMA in [RFC5213], re-instantiated filter(s) will be returned by LMA

only on MAG demand. This might happen when MAG renews PBU or create/modify/delete

its own filters.

The format of the option is briefly recalled hereafter. In an embodiment, it is proposed to extend the PRO field value in order to add

the (2: flow binding re-instantiated by LMA) predefined value. The

full specification of the option can be found in the above-recalled MEXT document

MAG behavior in an embodiment of he present invention will now be described.

The MAG upon MN attachment performs the steps as per [RFC5213].

In addition to this it performs the following checks.

The MAG learns if the MN is requesting a HNP as part of a new mobility session or if it is requesting to attach a new interface as part of an already existing mobility session. The MAG retrieves the

MHGID from e.g. MN's profile as well as filters. The MAG can learn

filters for example in an access-specific manner or alternatively via other

infrastructure support. In any case the MAG encodes the PBU including at least

the Multihoming option as specified before and possibly one or more

FID option(s).

The MAG can modify or delete filters attached to a multihoming group

by sending a PBU carrying the filter operation(s) to be performed.

It shall analyze individual results according to what is returned by

the LMA. In addition, MAG should be prepared to handle filters that

has been re-instantiated by LMA when MN has disconnected an interface

belonging to the same multihoming group.

When MAG proxying a MN detects the MN has detached the related

interface, MAG stops proxying the MN by sending a PBU with lifetime

set to 0 and includes the multihoming option that identifies the

target multihoming group of the detached interface as well as removal

behavior regarding filters. MAG waits o successful PBA to release

the MN access.

LMA behavior in an embodiment of the present invention will now be described.

The LMA should be modified in the BCE and conceptual data structures.

BCE modifications:

The LMA binding cache lookup method should be extended to accommodate

multihoming support. In case the LMA processes the Multihoming

Option it SHOULD update existing mobility session as defined in [RFC5213]. In addition to this it performs the following checks.

If the Multihoming option is present in the PBU, the LMA allocates/updates/deletes the mobility session and the multihoming group

ID it refers to. Flow filters received in the PBU are created/modified/deleted for the target Multihoming group ID and a result

shall be return on an individual filter basis.

In addition, the LMA handles removal of interfaces from

multihoming group according to MAG instructions. In particular, if a

MAG instructs a LMA to remove an interface from a multihoming group

but to keep filters, the LMA should re-instantiate filters on

existing interface(s) of the multihoming group according to its own

mechanisms.

If a LMA does not support multihoming extension (as a whole) or

specific multihoming option, as proposed by embodiments of the present document, it

may return a status code in PBA as defined in [RFC5213]. The later

specification might be extended to include multi-homing specific

statuses, such as:

MH_NOT_SUPPORTED_BY_LMA

MH_FILTERS_REINSTANCIATION_NOT_SUPPORTED_BY_LMA

In one aspect, in an embodiment, the present invention provides a method for improvement of a network-based IP mobility management protocol, said protocol running between Mobile Access Gateway MAG and Local Mobility Anchor LMA, said method including providing multihoming support, based on multihoming group information exchanged between MAG and LMA, said information identifying a group of interfaces of a Mobile Node MN to be managed by LMA on MAG demand under a same mobility session.

In an embodiment, said method comprises a step of:

upon attachment of a MN, MAG sending to LMA a Proxy Binding Update PBU including a Multihoming Option carrying said multihoming group information.

In an embodiment, said method comprises a step of:

upon attachment of a MN, MAG determining if the MN is provided with multihoming service, and if so, sending to LMA a Proxy binding Update PBU including a Multihoming Option carrying said multihoming group information.

In an embodiment, said method comprises a step of:

upon attachment of a MN, MAG sending to LMA a Proxy Binding

Update PBU including a Multihoming Option and Flow Identifier Option(s).

In an embodiment, said method comprises a step of:

upon reception from a MAG of a Proxy Binding Update PBU including multihoming group information, LMA performing a binding cache lookup and appending the information to the found Binding Cache Entry BCE.

In an embodiment, the choice of identifier MHGID of a multihoming group is such that all Proxy Binding Updates PBUs sent by MAG to LMA with some Home Network Prefix and MHGID values belong to the same mobility session from LMA perspective.

In an embodiment, a default multihoming group (id=0) is defined to represent all interfaces of a MN.

In an embodiment, said method comprises providing support of elementary operations on a group entity for a MN.

In an embodiment, said elementary operations include at least one of following operations: initial multihoming setup, multihoming renewal, multihoming filters modification, multihoming interface removal, multihoming interface addition. In addition to a method for improvement of a network-based IP mobility management protocol (examples of which have been described above), the present invention also has for its object different entities, such as in particular Mobile Access Gateway MAG and Local mobility Anchor LMA configured, in an embodiment, for performing such method.

In an embodiment, there is provided a Mobile Access Gateway MAG, configured to:

upon attachment of a MN, send to a LMA a Proxy Binding Update PBU including a Multihoming Option carrying multihoming group information, said information identifying a group of interfaces of a Mobile Node MN to be managed by a Local Mobility Anchor LMA on a Mobile Access Gateway MAG demand under a same mobility session.

In an embodiment, said Mobile Access Gateway MAG is configured to:

upon attachment of a MN, determine if a MN is provided with multihoming service, and if so, sending to LMA a Proxy binding Update PBU including a Multihoming Option carrying multihoming group information, said information identifying a group of interfaces of a Mobile Node MN to be managed by a Local Mobility Anchor LMA on a Mobile Access Gateway MAG demand under a same mobility session.

In an embodiment, said Mobile Access Gateway is configured to:

upon attachment of a MN, send to LMA a Proxy Binding Update PBU including a Multihoming Option and Flow Identifier Option(s).

In an embodiment, the choice of identifier MHGID of a multihoming group is such that all Proxy Binding Updates PBUs sent by MAG to LMA with same Home Network Prefix and MHGID values belong to the same mobility session from LMA perspective.

In an embodiment, a default multihoming group (id=0) is defined to represent all interfaces of a MN.

In an embodiment, said Mobile Access Gateway is configured to provide support of elementary operations on a group entity for a MN.

In an embodiment, said elementary operations include at least one of following operations: initial multihoming setup, multihoming renewal, multihoming filters modification, multihoming interface removal, multihoming interface addition.

In an embodiment, there is provided a Local Mobil y Anchor LMA, configured to:

perform a binding cache lookup and append the information to the found Binding Cache Entry BCE, upon reception from a MAG of a Proxy Binding Update PBU including multihoming group information, said information identifying a group of interfaces of a Mobile Node MN to be managed by a Local Mobility Anchor LMA on a Mobile Access Gateway MAG demand under a same mobility session.

In an embodiment, the choice of identifier MHGID of a multihoming group is such that all Proxy Binding Updates PBUs sent by MAG to LMA with same Home Network Prefix and MHGID values belong to the same mobility session from LMA perspective.

In an embodiment, a default multihoming group (id=0) is defined to represent all interfaces of a MN.

In an embodiment, said Local Mobility Anchor LMA is configured to provide support of elementary operations on a group entity for a MN.

In an embodiment, said elementary operations include at least one of following operations: initial multihoming setup, multihoming renewal, multihoming filters modification, multihoming interface removal, multihoming interface addition.

The detailed implementation of the above-mentioned configuration does not raise any special problem for a person skilled in the art, and therefore such configuration do not need to be more fully disclosed than has been made above, by their function, for a person skilled in the art.

A person of skill in the art would readily recognize that steps of various above-described methods can be performed by programmed computers. Herein, some embodiments are also intended to cover program storage devices, e.g., digital data storage media, which are machine or computer readable and encode machine-executable or computer-executable programs of instructions, wherein said instructions perform some or all of the steps of said above-described methods. The program storage devices may be, e.g., digital memories, magnetic storage media such as a magnetic disks and magnetic tapes, hard drives, or optically readable digital data storage media. The embodiments are also intended to cover computers programmed to perform said steps of the above-described methods.

1. A method for enhancing a network-based IP mobility management protocol to provide multihoming support, said method including providing multihoming support based on multihoming group information, said information identifying a group of interfaces of a Mobile Node MN to be managed by a Local Mobility Anchor LMA on a Mobile Access Gateway MAG demand under a same mobility session.

2. A method according to claim 1, including a step of:
upon attachment of a MN, MAG sending to LMA a Proxy Binding Update PBU including a Multihoming Option carrying said multihoming group information.

3. A method according to claim 1, including a step of:
upon attachment of a MN, MAG determining if the MN is provided with multihoming service, and if so, sending to LMA a Proxy binding Update PBU including a Multihoming Option carrying said multihoming group information.

4. A method according to claim 2, including a step of:
upon attachment of a MN, MAG sending to LMA a Proxy Binding Update PBU including a Multihoming Option and Flow Identifier Option(s).

5. A method according to claim 1, including a step of:
upon reception from a MAG of a Proxy Binding Update PBU including multihoming group information, LMA performing a binding cache lookup and appending the information to the found Binding Cache Entry BCE.

6. A method according to claim 1, wherein the choice of identifier MHGID of a multihoming group is such that all Proxy Binding Updates PBUs sent by MAG to LMA with same Home Network Prefix and MHGID values belong to the same mobility session from LMA perspective.

7. A method according to claim 1, wherein a default multihoming group (id=0) is defined to represent all interfaces of a MN.

8. A method according to claims 1, including providing support of elementary operations on a group entity for a MN.

9. A method according to claim 8, wherein said elementary operations include at least one of following operations: initial multihoming setup, multihoming renewal, multihoming filters modification, multihoming interface removal, multihoming interface addition.

10. A Mobile Access Gateway MAG, configured to perform a method according to claim 1.

11. A Local Mobility Anchor LMA, configured to perform a method according to claim 1.
